(19) United States
(12) Patent Application Publication
(10) Pub. No.: US 2005/0052064 A1
(43) Pub. Date: Mar. 10, 2005

(54) Seat recliner mechanism incorporating a rotatable cam co-acting within an interiorly apertured pawl

(76) Inventors: Stephen Bruck, Howell, MI (US); David Grable, Clinton Township, MI (US)

Correspondence Address: GIFFORD, KRASS, GROH, SPRINKLE;ANDERSON & CITKOWSKI, PC, 280 N OLD WOODARD AVE, SUITE 400, BIRMINGHAM, MI, 48009, US

(21) Appl. No.: 10/659,147

(22) Filed: Sep. 10, 2003

(51) Int. Cl. B60N 2/02

(52) U.S. Cl. 297/369

(57) ABSTRACT

A seatback recliner mechanism including a frame incorporated into a seat bottom and a seatback arm pivotally secured to the frame. The seatback arm includes a lower arcuate surface upon which are defined a first plurality of serrations. A pawl is hingedly secured to the frame and incorporates a second plurality of serrations, the pawl further includes an interior aperture defined by an inner wall configuration. A cam is rotatably secured to the frame in seating fashion within the inner wall configuration, the cam exhibiting a specified exterior configuration. A lever is pivotally secured to the cam and extending from an outer plate associated with the frame. In use, the cam is rotated in a first direction, such that said exterior configuration engages the inner wall configuration of the pawl and to bias the second plurality of serrations in abutting contact against the first plurality of serrations. The cam is further capable of being rotated in a second direction to cause the pawl to hingedly disengage from abutting contact with the seatback arm and to permit angular readjustment of the arm relative to the seat bottom.

### BACKGROUND OF THE INVENTION

1. Field of the Invention

The present invention relates generally to seat recliner mechanism. More specifically, the present invention discloses a seatback recliner mechanism incorporating a rotatable cam co-acting within an interiorly apertured pawl and which both reduces the requirement of an additional actuator component, as well as reducing looseness (“chucking”) about the seatback pivot.

2. Description of the Prior Art

The prior art is well documented with various types of seatback reclining and adjusting mechanisms. Among these are included latching, or other suitable types of locking pivot mechanisms, for the purpose of preventing unwanted “chucking” of the seatback assembly. The term “chucking” is generally defined as the undesirable looseness of a pawl of other member pivotally and meshingly associated with a seatback, and such as which typically results from the relative movement of the interengaging teeth established between the members.

A first example from the prior art is set forth in U.S. Pat. No. 6,412,849 issued to Fast, and which teaches a chuck free latch assembly having a housing, latch, release cam coupled to the housing, spring means and a release mechanism. Of particular note, the release cam is operable in an engaged position and wherein the release cam urges the latch toward its latched position and in a released position wherein the latch is operable in its unlatched position. The spring means urges the release cam toward its engaged position and the latch is operable in its unlatched position.

U.S. Pat. No. 5,749,625, issued to Robinson, teaches a seat recliner for reduced chucking and including a seatback with a toothed quadrant, a toothed pawl, and an engagement member. The engagement member is biased against the pawl and which, in turn, is forced into engagement with the quadrant to lock the quadrant against rotation, thus again reducing chucking. Finally, U.S. patent application Publication, No. 2002/0024246 to Yamada et al. teaches a seat recliner mechanism including, in relevant part, a configured and rotatable cam 6 (see FIG. 3) which operates against a pair of opposingly positioned pawls 4 and 5 and, in relevant part, to urge the gear portion 42 of the upper pawl 4 into engagement with an inner gear portion 21 associated with an upper arm 2.

### SUMMARY OF THE PRESENT INVENTION

The present invention discloses a seatback recliner mechanism incorporating a rotatable cam co-acting within an interiorly apertured pawl and which both reduces the requirement of an additional actuator component, as well as reducing looseness (“chucking”) about the seatback pivot. In particular, the present invention establishes an improvement over the prior art in that it establishes a more secure and co-acting engagement/disengagement between the interengaging teeth associated with a seatback and a biasingly influenced and pivotally associated pawl.

A frame is incorporated into the seat bottom and includes a pair of spaced apart inner and outer plates. A seatback arm is sandwichingly engaged in pivotal fashion between said inner and outer plates and by virtue of a cam and pawl arrangement likewise mounted between the inner and outer plates.

The seatback arm includes a first plurality of serrations extending along a lower arcuate surface and the opposing and hingedly associated pawl includes a second plurality of serrations extending along an opposing and upper arcuate surface. The cam is rotatably mounted, by virtue of a lever extending from the seat bottom frame, within an aperture defined in the pawl.

An inner wall configuration of the pawl exhibits a first plurality of projections, whereas an exterior configuration of the cam exhibits a second plurality of projections which co-act with the inner wall configurations of the pawl. In this fashion, and depending upon the rotational direction imparted upon the cam, the serrations along the pawl are either biased in interengaging fashion against those defined along the seatback arm (to thereby eliminate “chucking”) or, alternatively, to disengage and downwardly pivot the pawl away from the seatback arm.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of an assembled seat recliner mechanism according to the present invention;

FIG. 2 is a front cutaway view of the seat recliner mechanism, revealed by the removal of the outer plate, and which illustrates the seatback arm and pawl in an engaged position;

FIG. 3 is an exploded view of the seat recliner mechanism according to the present invention; and

FIG. 4 is a front view, substantially as illustrated in FIG. 2, and further showing the pawl in a disengaged position relative to the seatback arm.

### DETAILED DESCRIPTION OF THE PREFERRED EMBODIMENTS

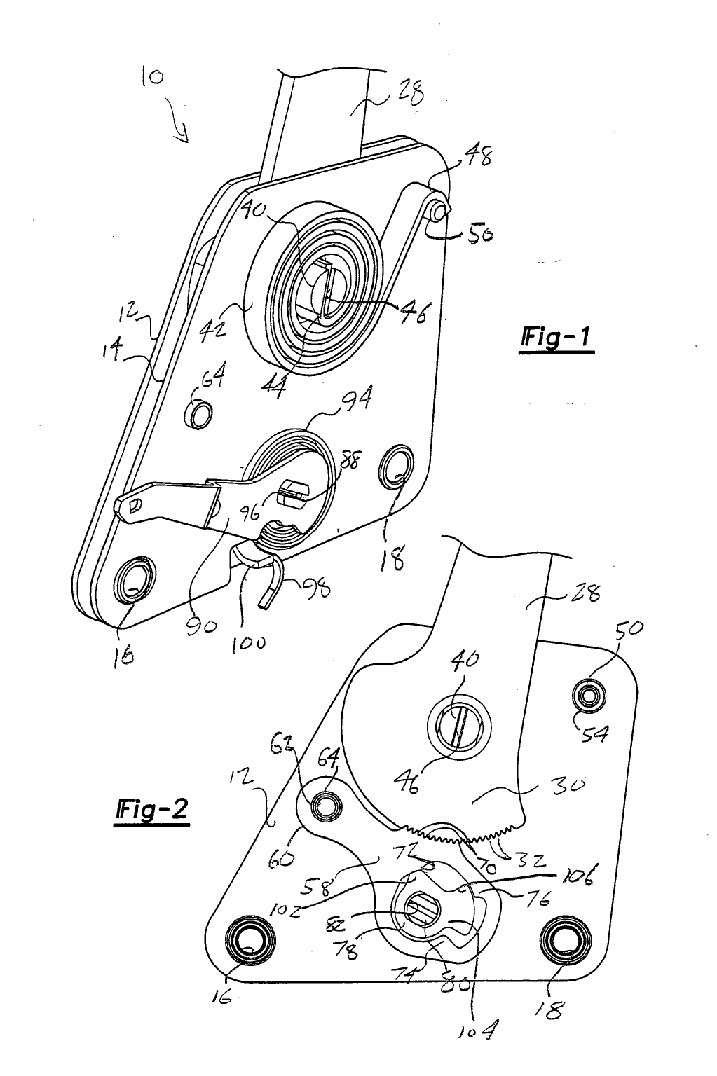

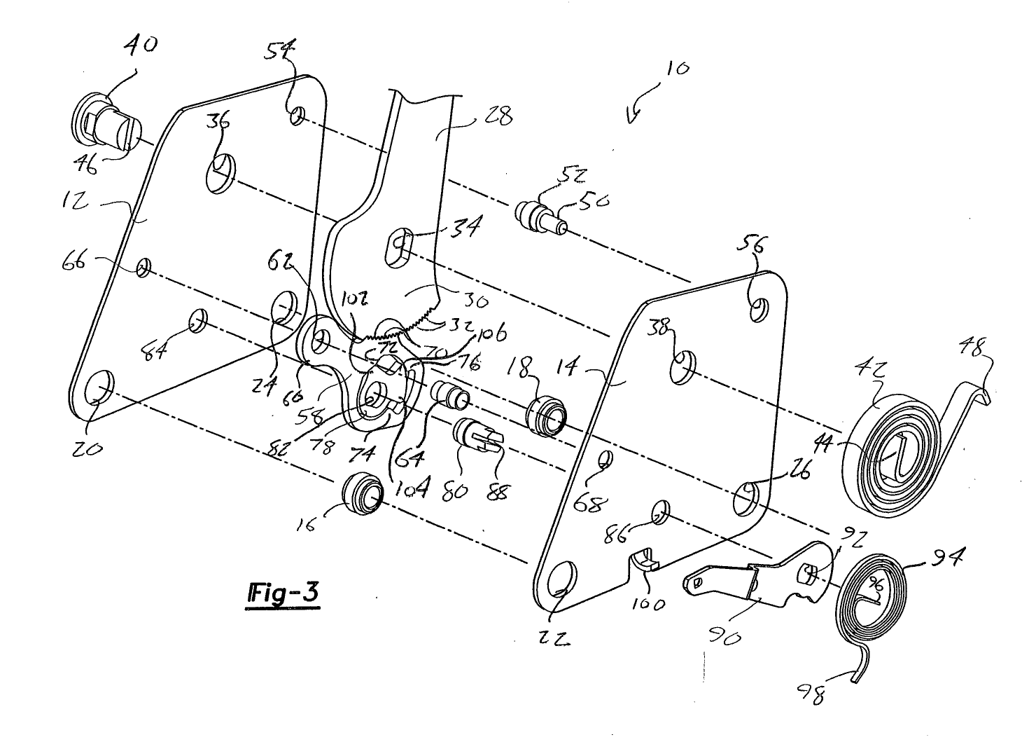

Referring now to the environmental perspective view of FIG. 1, as well as the exploded view of FIG. 3, a seat recliner mechanism is illustrated at 10 according to a preferred embodiment of the present invention. As previously described, the present invention discloses an improved recliner mechanism for establishing a more secure and co-acting engagement/disengagement between the interengaging teeth associated with a seatback and a biasingly influenced and pivotally associated pawl. In particular, and referencing in particular the engaged illustration of FIG. 2, the manner in which the pawl is biasingly engaged against the seatback arm prevents instances of “chucking”; which is further defined as being the undesirable movement of the arm relative to the pawl, and normally resulting from inadequate biasing forces established between the meshingly interengaged pluralities of serrations (teeth).

As best shown again in FIGS. 1 and 3, a seat frame is illustrated and includes an inner plate 12 and a spaced apart outer plate 14. The plates 12 and 14 are both substantially planar shaped, typically constructed of a durable metal or steel material, and exhibit a desired, such as four-sided, exterior configuration. The plates 12 and 14 are maintained in a desired and spaced-apart relationship, in part through the provision of a pair of spacer bushings 16 and 18 which seat within aligning pairs of enclosed and inwardly facing walls defining apertures, see further at 20 and 22 and 24 and 26 in both inner plate 12 and outer plate 14 and as is best shown in the exploded view of FIG. 3. Additionally, and although not shown, it is understood that a typical seat bottom includes a pair of such spaced-apart frames located on opposite sides thereof.

The seatback arm is illustrated at 28, also typically constructed of steel, and includes an arcuate shaped lower end 30, upon a downwardly facing surface thereof are further exhibited a first plurality of serrations 32. Also included is an aperture 34, located in a substantially central fashion relative the lower end 30. A pair of aligning apertures 36 and 38 are defined at locations through the plates 12 and 14 and, upon aligning with the aperture 34, receive in inserting fashion therethrough a main pivot pin 40.

A main coil spring is illustrated at 42, a first inner end 44 of which seats within a slot recess 46 defined in the projecting end of the main pivot pin 40 and in order to secure the main spring 42 upon the exterior face of the outer plate 14. A remote projecting end 48 of the main coil spring 42 exhibits a substantially curled shape and is engaged by a likewise projecting end 50 of a rivet 52, this being further seatingly engaged through aligning recesses 54 and 56 in the plates 12 and 14, respectively and such that the seatback arm 28 is biased in a forwardly pivoting direction.

The pawl is illustrated by the generally elongated body 58 and includes a first rounded end 60 exhibiting an aperture 62. A rivet 64 extends through a further pair of aligning apertures 66 and 68 (see again FIG. 3) in the plates 12 and 14, and so that the pawl 58 is hingedly secured in likewise sandwiched fashion between the plates 12 and 14.

An upper arcuate surface associated with the pawl 58 exhibits thereupon a second plurality of serrations 70 and which are arrayed in opposing fashion relative to the first plurality of serrations 32 associated with the lower arcuate end 30 of the seatback arm 28. The pawl 58 further exhibits an interior aperture defined by a plurality of inner wall configurations. Specifically, and as is best shown in FIGS. 2-4, the inner wall configurations are further defined by inward projections at circumferentially spaced apart locations 72, 74 and 76.

A cam is illustrated at 78 and which, as will now be explained, is rotatively mounted within the pawl interior aperture. A cam pivot pin 80 extends through a central aperture 82 defined in the cam 78, in addition to aligning apertures 84 and 86 in the inner 12 and outer 14 plates.

An extending end of said cam pivot pin 80 is, similar to the main pivot pin 40, slotted, such as at 88. A lever 90 is provided and includes an aperture 92 through which the extending end of the cam pivot pin 80 extends and so that the lever 90 is also secured to the exterior face of the outer plate 14. A secondary coil spring 94 includes an inner end 96 which, similarly to the corresponding inner end 44 associated with the main coil spring 42, is seated within the slot 88 of the cam pivot pin 80 and so that the secondary coil spring is secured to the exterior face of the outer plate 14. A remote extending end 98 of the secondary coil spring 94 is also arcuately bent and such that it engages an angled projection 100 (see FIGS. 1 and 3) associated with the outer plate 14 and in order to bias the lever 90, as well as the pivotally slaved cam 78, in a counter-clockwise direction.

The cam 78 further exhibits a specified exterior configuration including the provision outward projections 102, 104 and 106. In operation, and referring first to the engaged view of FIG. 2, the cam 78 is in its counter-clockwise biased position and further such that its exterior cam projection 102 co-acts with opposing inward projection 72, associated with the pawl aperture. In this position, the pawl 58, and in particular its upwardly facing serrations 70, are biased in a generally upward direction against the corresponding downward projections 32 of the seatback arm 28.

Additionally, the upward influence exerted by co-acting portions 72 and 102 biases the clearance existing between the aperture 62 and rivet 64 at the pawl hinged end, and thereby to eliminate the existence of “chucking” between the interengaging serrations, the same again being defined as the undesirable looseness existing at the seatback pivot. The interior positioning of the cam 78 within the pawl 58 further eliminates the requirement of an extra actuator component for the seatback recliner package and which would otherwise be required if the cam 78 were positioned at some location in which it abuttingly contacts the pawl 58 at an exterior location.

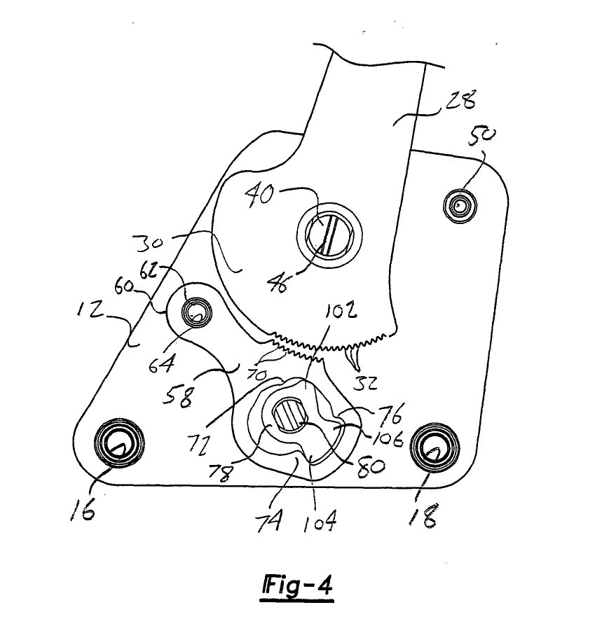

Referring finally to the cutaway and disengaged view of FIG. 4, the cam 78 is illustrated in a clockwise-rotated position, resulting from likewise clockwise rotation of the handle 90 and in a direction opposite the bias of the secondary spring 94. At this location, the exterior co-acting projection 102 of the cam 78 disengages from abutting contact with the recessed projection 102 defined along the inner wall surface of the pawl aperture and reseats in a recessed adjoining boundary between locations 72 and 76 along the inner wall surface.

The above, combined with the clearances provided between the associated pairs of cam/pawl configurations (see in particular 104 and 74 and 106 and 76), allows the pawl 58 to disengage in a clockwise direction about its hinged end 60 connection from the seatback arm and so that the respective pluralities of serrations 32 and 70 are no longer meshingly engaged. In this position, the seatback arm 28 (and associated seatback) can be pivotally readjusted (against the forward bias exerted by the main spring 42) and until the lever 90 is released, reseating the serrations 32 and 70 in a desired angled position.

Having described my invention, other and additional preferred embodiments will become apparent to those skilled in the art to which it pertains, and without deviating from the scope of the appended claims:

1. A seatback recliner mechanism, comprising:
a frame incorporated into a seat bottom and a seatback arm pivotally secured to said frame;
said seatback arm including a lower arcuate surface upon which are defined a first plurality of serrations;
a pawl hingedly secured to said frame and incorporating a second plurality of serrations, said pawl further includes an interior aperture defined by an inner wall configuration;
a cam rotatably secured to said frame in seating fashion within said inner wall configuration, said cam exhibiting a specified exterior configuration;
a lever pivotally secured to said cam and extending from said frame; and
said cam being rotated in a first direction, such that said exterior configuration engages said inner wall configuration of said pawl and to bias said second plurality of serrations in abutting contact against said first plurality of serrations, said cam being rotated in a second direction to cause said pawl to hingedly disengage from abutting contact with said seatback arm.

2. The seatback recliner mechanism as described in claim 1, said second plurality of serrations extending along an upper arcuate surface of said pawl extending in substantially opposing fashion relative to said lower arcuate surface of said seatback arm.

3. The seatback recliner mechanism as described in claim 1, said inner wall configuration of said pawl comprising a first plurality of projections, said exterior configuration of said cam comprising a second plurality of projections which co-act with said first plurality of projections between said first and second rotated directions.

4. The seatback recliner mechanism as described in claim 3, each of said pawl and cam further comprising first, second and third co-acting projections.

5. The seatback recliner mechanism as described in claim 1, said frame further comprising an inner plate and a spaced apart outer plate sandwiching therebetween said pawl, cam and pivotally secured seatback.

6. The seatback recliner mechanism as described in claim 5, further comprising a main pivot pin extending through aligning apertures in said spaced-apart inner and outer plates, a main coil spring securing to an exterior face of said outer plate and biasing said seatback arm in a forwardly pivoting direction.

7. The seatback recliner mechanism as described in claim 5, further comprising a cam pivot pin extending through a central aperture defined in said cam and additional aligning apertures in said inner and outer plates, an extending end of said cam pivot pin engaging said lever.

8. The seatback recliner mechanism as described in claim 7, further comprising a secondary coil spring secured to an exterior face of said outer plate and biasing said lever in a counter-clockwise direction.

9. The seatback recliner mechanism as described in claim 5, further comprising a pawl rivet seating through an aperture in said pawl defining said hinged connection, said pawl rivet seating through additional and aligning apertures in said inner and outer plates.

10. The seatback recliner mechanism as described in claim 5, further comprising a pair of spacer bushings engaging additional and aligning pairs of apertures in said inner and outer plates.

11. The seatback recliner mechanism as described in claim 6, further comprising an extending end of said main coil spring engaging a projecting end of a rivet extending between top rear locations associated with said inner and outer plates.

12. The seatback recliner mechanism as described in claim 8, further comprising an extending end of said secondary coil spring engaging an angled projection associated with said outer plate.

13. A seatback recliner mechanism, comprising:
a frame incorporated into a seat bottom, said frame including an inner plate and a spaced-apart outer plate, a seatback arm sandwiched between said inner and outer plates and so as to be pivotally secured to said frame;
said seatback arm including a lower arcuate surface upon which are defined a first plurality of serrations;
a pawl hingedly secured to said frame and incorporating a second plurality of serrations extending along an upper arcuate surface in substantially opposing fashion relative to said first plurality of serrations, said pawl further includes an interior aperture defined by an inner wall configuration exhibiting a first plurality projections;
a cam rotatably secured to said frame in seating fashion within said inner wall configuration, said cam exhibiting a specified exterior configuration exhibiting a second plurality of projections which co-act with said first plurality of projections associated with said cam;
a lever pivotally secured to said cam and extending from said outer plate; and
said cam being rotated in a first direction, such that said exterior configuration engages said inner wall configuration of said pawl and to bias said second plurality of serrations in abutting contact against said first plurality of serrations, said cam being rotated in a second direction to cause said pawl to hingedly disengage from abutting contact with said seatback arm.
